(19) United States
(12) Patent Application Publication
(10) Pub. No.: US 2022/0222578 A1
(43) Pub. Date: Jul. 14, 2022

(54) METHOD OF TRAINING LOCAL MODEL OF FEDERATED LEARNING FRAMEWORK BY IMPLEMENTING CLASSIFICATION OF TRAINING DATA

(71) Applicant: RESEARCH & BUSINESS FOUNDATION SUNGKYUNKWAN UNIVERSITY, Suwon-si (KR)

(72) Inventors: Jee Hyong LEE, Suwon-si (KR); Seok Kyu KANG, Suwon-si (KR); Mann Soo HONG, Suwon-si (KR); Ji Young LIM, Suwon-si (KR)

(73) Assignee: RESEARCH & BUSINESS FOUNDATION SUNGKYUNKWAN UNIVERSITY, Suwon-si (KR)

(21) Appl. No.: 17/576,042

(22) Filed: Jan. 14, 2022

(30) Foreign Application Priority Data
Jan. 14, 2021 (KR) 10-2021-0005483

(51) Int. Cl. G06N 20/00; G06F 16/28

(52) U.S. Cl. CPC G06N 20/00; G06F 16/285

(57) ABSTRACT

A local model training method of a federated learning framework implementing training data classification is provided. In the local model training method, a client may classify training data into two categories, generate a learning mini-batch by adjusting a ratio between samples classified into the two categories and included in the mini-batch to a preset ratio, and train a learning model using the mini-batch with the adjusted sample ratio.

### CROSS-REFERENCE TO RELATED APPLICATIONS

This application claims the benefit under 35 U.S.C. § 119(a) of Korean Patent Application No. 10-2021-0005483, filed on Jan. 14, 2021, in the Korean Intellectual Property Office, the entire disclosure of which is incorporated herein by reference for all purposes.

### BACKGROUND

### 1. Field

The following description relates to a method of training a local model of a federated learning framework by implementing classification of training data.

### 2. Description of Related Art

Federated learning is a deep learning method that protects sensitive information including personal information. A method of generating a global model encompassing all local models of clients (also referred to as participants, parties, edge devices, nodes, users, etc.) participating in a federated learning network may be implemented.

More specifically, each client may collect data, train the local model, and upload information on the trained local model to a server. The server may collect information on local models, update a global model, and transmit information on the updated global model to a client. The client may update the local model with the information on the global model received from the server.

In this process, only information on the global model and the local model is exchanged between the server and the client, and thus there is no concern that the data collected by the client would be delivered to the outside, which has an advantage in terms of information protection.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a processor-implemented federated learning framework local model training method, includes classifying, by a client, training data into two categories; generating, by the client, a learning mini-batch by adjusting a ratio between samples classified into the two categories and included in the learning mini-batch to a preset ratio; and training, by the client, a learning model by implementing the mini-batch with the adjusted sample ratio.

In the classifying the training data into the two categories, the client may be configured to classify the training data into a forgettable sample and an unforgettable sample.

The client may be configured to classify the training data into the forgettable sample and the unforgettable sample based on catastrophic forgetting.

The client may be configured to classify the training data into the forgettable sample and the unforgettable sample by comparing a result obtained by training the learning model with the training data, and a result obtained by retraining, with the training data, the learning model trained with the training data.

The client is configured to classify a sample in which a result obtained by training the learning model with the training data is different from a result obtained by retraining the learning model with the training data as the forgettable sample.

The client may be configured to classify a sample in which a result obtained by retraining the learning model with the training data is an incorrect answer, among samples in which a result obtained by training the learning model with the training data is a correct answer, as the forgettable sample.

The client may be configured to receive the preset ratio from a server.

The client may be configured to receive information on the learning model from a server before the client classifies the training data into the two categories.

The client may be configured to transmit information on the trained learning model to the server after the client trains the learning model.

The information on the learning model and the information on the trained learning model may be weights for the learning model.

Other features and aspects will be apparent from the following detailed description, the drawings, and the claims.

### BRIEF DESCRIPTION OF DRAWINGS

FIG. 1 illustrates an example a system in which federated learning is performed, in accordance with one or more embodiments.

FIG. 2 is a flowchart illustrating an example method of performing federated learning, in accordance with one or more embodiments.

FIG. 3 is a flowchart illustrating an example local model training method of an example federated learning framework implementing training data classification, in accordance with one or more embodiments.

FIG. 4 illustrates an example of implementing an example local model training method of a federated learning framework implementing training data classification, in accordance with one or more embodiments.

FIGS. 5A to 5D illustrate a result of comparing the performance of a typical learning model implementing FedAvg and the performance of a learning model implementing a local model training method of an example federated learning framework implementing a training data classification, in accordance with one or more embodiments.

FIG. 6 illustrates a performance according to the portion of samples in an example local model training method of a federated learning framework implementing a training data classification, in accordance with one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings, and like reference numerals in the drawings refer to like elements throughout.

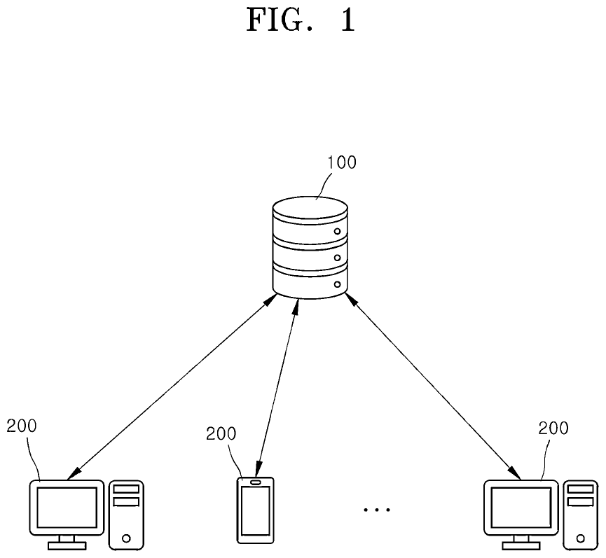

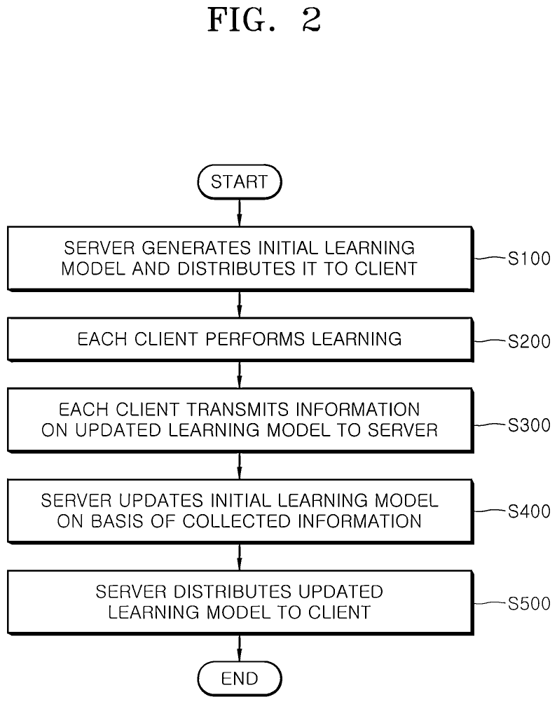

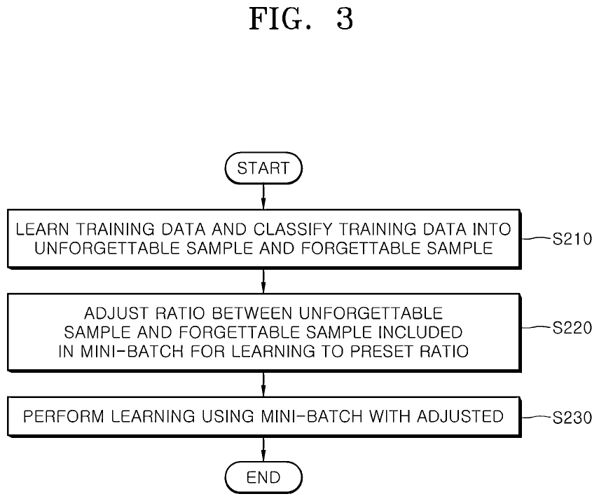

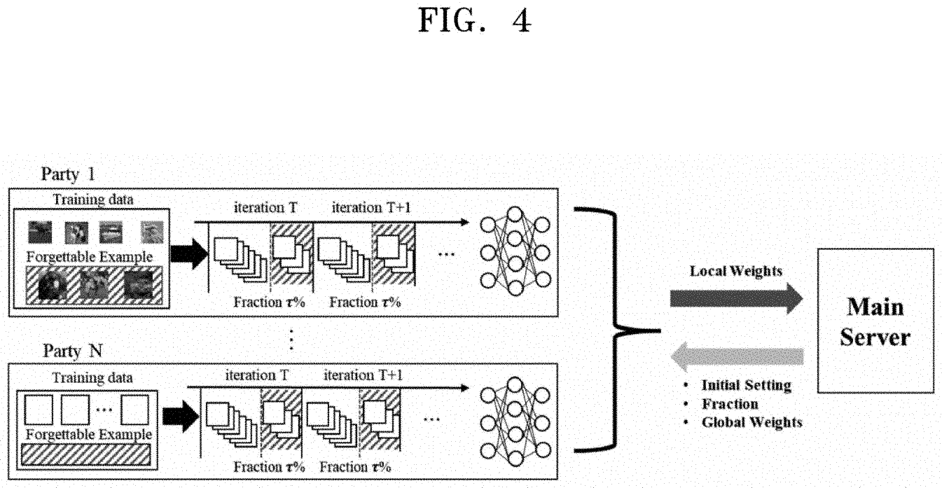

FIG. 1 illustrates an example system in which federated learning is performed, in accordance with one or more embodiments. FIG. 2 is a flowchart illustrating an example method of performing federated learning, in accordance with one or more embodiments. FIG. 3 is a flowchart illustrating an example local model training method of an example federated learning framework implementing training data classification, in accordance with one or more embodiments. FIG. 4 illustrates an example of implementing the local model training method of the federated learning framework using the training data classification, in accordance with one or more embodiments. The local model training method of the federated learning framework implementing the training data classification, in accordance with one or more embodiments, will be described with reference to the drawings.

Referring to FIG. 1, the federated learning may be performed in a system including a server 100 and one or more clients 200.

The server 100 and the clients 200 may include a processor that performs deep learning operations, a storage device that stores a learning model, training data, etc., and a communication device that enables communication therebetween, and the like, and one or more clients 200 may be connected to the server 100 to perform federated learning.

In an example, a user's smart device, personal computer, etc. may be used as the client 200.

Referring to in FIG. 2, the federated learning may be performed through the following process.

First, the server 100 may generate an initial learning model (global model) using training data held in the server 100, and distribute the learning model to the clients 200 (operation S100). Subsequently, each client 200 may perform learning using training data held in each client 200 (operation S200). When the learning is performed in this manner, each client 200 may have an individually updated learning model (local model), and each client 200 may transmit information on the learning model updated in this manner to the server 100 (operation S300). The server 100 may update the initial learning model (global model) based on the information collected from the clients 200 (operation S400) and distribute the updated learning model to the clients 200 (operation S500).

The training of the local model, and the update of the global model, may be repeatedly performed to perform the federated learning.

At this time, the information transmitted by the clients 200 to the server 100 may include the weights of the learning models, and the information transmitted when the server 100 distributes the updated learning model to the clients 200 may also include the weights. In the one or more examples, the weights may refer to a set of learnable variables implementing a deep learning neural network, and the server 100 may improve the global model with the collected weights.

Additionally, for this federated learning, a FedAvg algorithm (H. B. McMahan et al., Communication-Efficient Learning of Deep Networks from Decentralized Data, 2016.), a FedMA algorithm, (H. Wang et al., Federated Learning with Matched Averaging, 2019.), or a FedProx algorithm (T. Li et al, Federated Optimization in Heterogeneous Networks, 2018.) may be used. Additionally, various known algorithms may be applied.

However, since the application of the above-described algorithms and the operation method of the federated learning implementing weights correspond to those widely known to those skilled in the art, a detailed description thereof will be omitted herein.

As shown in FIGS. 3 and 4, the local model training method of the federated learning framework implementing the training data classification, in accordance with one or more embodiments, may be performed as follows in training the local model of the client 200.

First, the client 200 may classify the training data by classifying the degree of significance of learning.

Specifically, the client 200 may classify the training data into two categories and classify data more useful for learning and general data.

For example, the client 200 may classify data meaningful for learning on the basis of a catastrophic forgetting phenomenon. The catastrophic forgetting phenomenon refers to a phenomenon in which the learning model forgets learned data. That is, when there is a model f(x) that correctly predicts data x1, the value of f(x1) for x1 changes after learning x2, and there is data that cannot be predicted correctly. The data may correspond to a forgettable sample.

In an example, there may be an unforgettable sample, which is not forgotten after being learned in the learning model, and the client 200 may classify the training data into a forgettable sample and an unforgettable sample.

The classification between the forgettable sample and the unforgettable sample may be performed by training the learning model with the training data to test whether the data is forgotten or unforgotten.

That is, the client 200 may learn the training data and classify the training data into a forgettable sample and an unforgettable sample (operation S210).

Specifically, first, the client 200 may record a result obtained by training the learning model (local model) with the training data. The client 200 may determine that a sample having a different result obtained by retraining the learning model with the training data corresponds to a forgettable sample.

Alternatively, when retraining the learning model with samples that give correct answers when learning the training data, the client 200 may determine that a sample that does not give a correct answer corresponds to a forgettable sample.

Additionally, when learning the training data, the client 200 may determine that samples that do not give correct answers from the beginning correspond to forgettable samples.

The client 200 may be configured to classify the training data into a forgettable sample and an unforgettable sample, and add a flag to the training data.

Subsequently, the client 200 may configure the training data in a mini-batch for learning, and adjust the ratio between the forgettable sample and the unforgettable sample included in the mini-batch to a preset ratio (operation S220).

The above-described forgettable sample and unforgettable sample may be respectively regarded as data that is difficult for the model to learn, and data that is easy for the model to learn. Therefore, although both the forgettable sample and the unforgettable sample are beneficial for learning, the forgettable sample may be more important than the unforgettable sample in determining the performance of the deep learning model.

Therefore, the performance of the deep learning model may be further improved by repeatedly exposing forgettable samples during the learning process.

Additionally, samples that do not give correct answers may have a characteristic that should be ignored, which may make learning difficult. In an example, even when an image of a dog image includes an excessively small dog, or even when an image of a dog includes an arm of a person who is holding the dog, the image may be repeatedly exposed to a learning model that distinguishes dog images, so that the learning model may give a first weight to a part of the image to be considered important, and lower the weight of a part of the image to be ignored.

However, it may be necessary to set such a ratio to an appropriate level because forgettable samples can make it difficult to train the model.

In this example, the ratio between forgettable samples and unforgettable samples may be transmitted from the server 100 to the client 200. The server 100 may be configured to choose the ratio in consideration of the type of deep learning model, or may be configured to set the ratio when a user inputs the ratio to the server 100.

In an example, as described above, in the federated learning, when each local model is trained in the clients 200, the learned information is aggregated to the server 100, and the server 100 may update the global model with the information and distribute the global model to the clients 200. Thus, changes and loss of information may occur in each local model. Therefore, it may be more likely to forget a previously learned sample than in a typical deep learning environment.

That is, the probability of a catastrophic forgetting event occurring may be higher in the federated learning environment than in a general deep learning environment. Therefore, in the one or more examples, the performance of the learning model may be improved by adjusting the ratio between the forgettable samples and the unforgettable samples when configuring the mini-batch.

Subsequently, the client 200 may perform learning using the mini-batch with the adjusted sample ratio (operation S230). That is, the client 200 may perform the learning by configuring the mini-batch to contain a certain proportion of forgettable samples while configuring the mini-batch randomly.

When the learning is completed, the client 200 may proceed to the above-described operation S300 of FIG. 2, and transmit information of the updated learning model to the server 100.

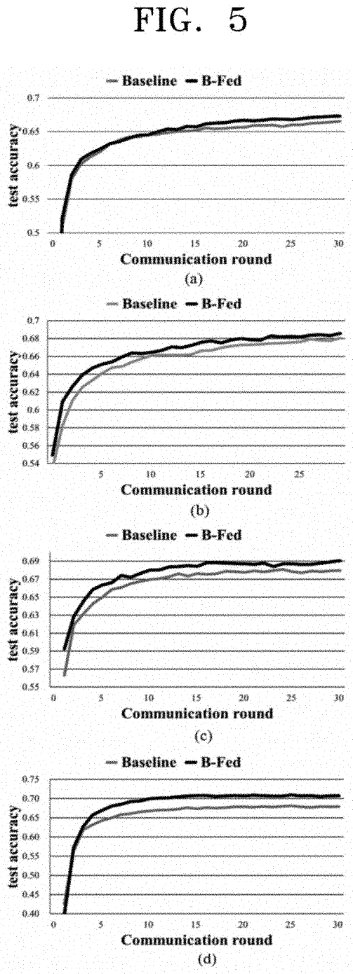

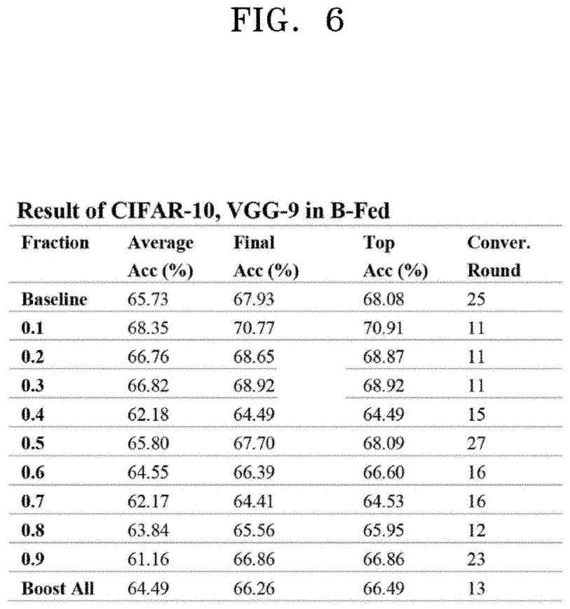

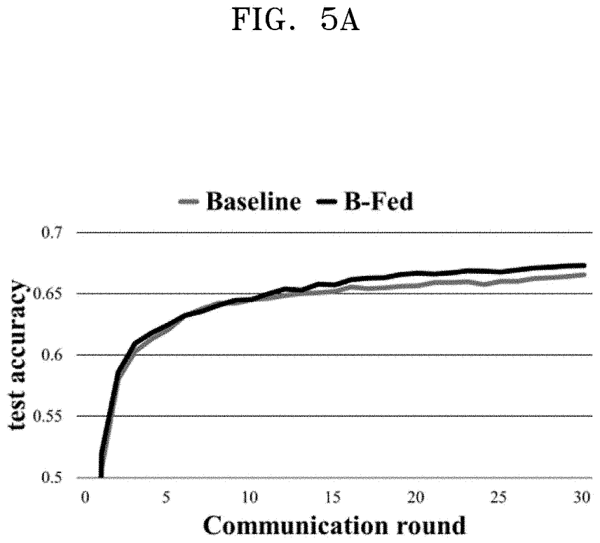

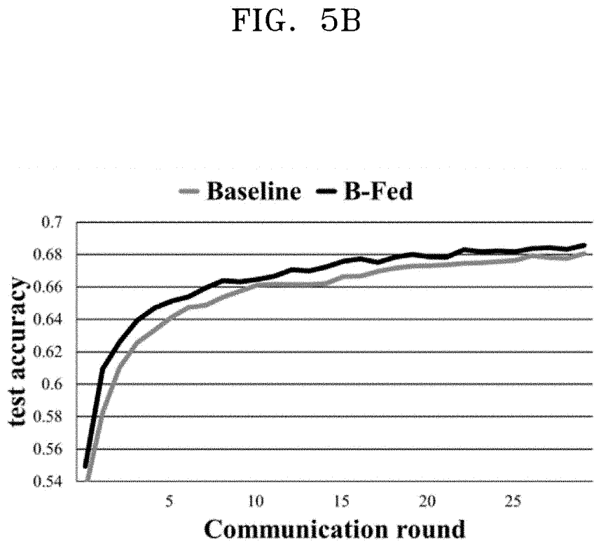

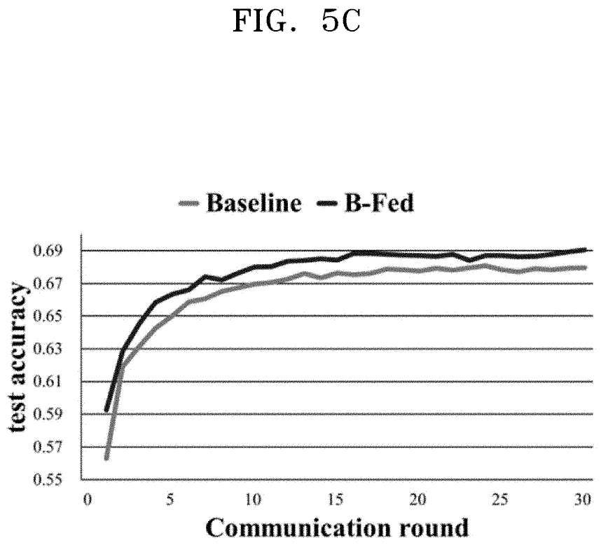

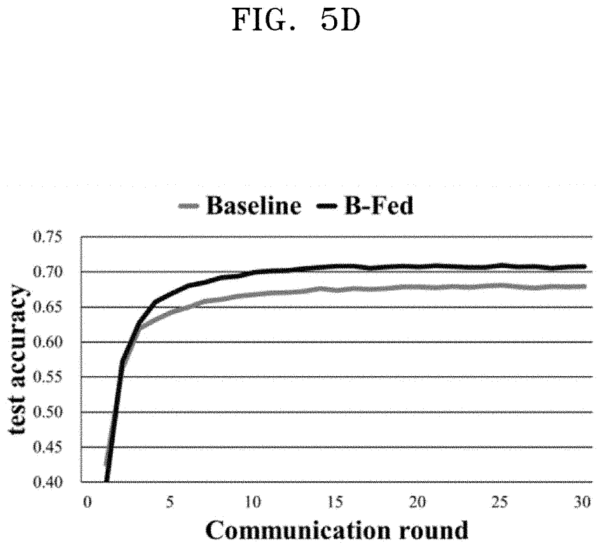

FIGS. 5A to 5D illustrate a result of comparing the performance of a typical learning model implementing FedAvg and the performance of a learning model implementing the local model training method of the federated learning framework implementing the training data classification, in accordance with one or more embodiments.

In the test of FIGS. 5A to 5D, a CIFAR-10 image dataset was used. Image data was randomly distributed by creating virtual clients, and the performance indicator shown in the figure refers to an accuracy. The method in the one or more examples may be referred to as Sample Boosted Federated Learning (B-Fed).

In FIGS. 5A and 5B, the LeNet-5 model was used and applied to 28 and 16 virtual clients, respectively. In FIGS. 5C and 5D, VGG-9 was used and applied to 16 virtual clients, and the numbers of epochs were different, i.e., 10 and 20, respectively. The weighted proportion of forgettable samples is 30%. The difference between FedAvg and B-Fed is 1 to 3%, and, at any point in time, B-Fed may outperform FedAvg by 1% or more.

FIG. 6 illustrates the performance according to the portion of samples in the local model training method of the federated learning framework using the training data classification, in accordance with the one or more embodiments.

FIG. 6 illustrates a result when only the weighted proportion of forgettable samples is changed under the same conditions as in FIG. 5. Baseline means FedAvg because the weighted proportion is 0%, and Boost All means 100%. As can be seen from FIG. 6, when the weighted proportion of forgettable samples is excessively increased, conversely, performance is degraded. Above 40%, the average performance and even the final performance are lower than those of FedAvg. However, below 40%, the average performance, the final performance, the peak performance, and convergence time are all higher than those of FedAvg by about 1-3%.

With the local model training method of a federated learning framework using training data classification according to the present invention, by classifying training data and adjusting the portion of samples included in a mini-batch so that data having a greater impact on learning performance is more learned, it is possible to increase the performance of the learning model.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented federated learning framework local model training method, comprising:
classifying, by a client, training data into two categories;
generating, by the client, a learning mini-batch by adjusting a ratio between samples classified into the two categories and included in the learning mini-batch to a preset ratio; and
training, by the client, a learning model by implementing the mini-batch with the adjusted sample ratio.

2. The method of claim 1, wherein in the classifying the training data into the two categories, the client is configured to classify the training data into a forgettable sample and an unforgettable sample.

3. The method of claim 2, wherein the client is configured to classify the training data into the forgettable sample and the unforgettable sample based on catastrophic forgetting.

4. The method of claim 2, wherein the client is configured to classify the training data into the forgettable sample and the unforgettable sample by comparing a result obtained by training the learning model with the training data, and a result obtained by retraining, with the training data, the learning model trained with the training data.

5. The method of claim 4, wherein the client is configured to classify a sample in which a result obtained by training the learning model with the training data is different from a result obtained by retraining the learning model with the training data as the forgettable sample.

6. The method of claim 4, wherein the client is configured to classify a sample in which a result obtained by retraining the learning model with the training data is an incorrect answer, among samples in which a result obtained by training the learning model with the training data is a correct answer, as the forgettable sample.

7. The method of claim 1, wherein the client is configured to receive the preset ratio from a server.

8. The method of claim 1, wherein the client is configured to receive information on the learning model from a server before the client classifies the training data into the two categories.

9. The method of claim 8, wherein the client is configured to transmit information on the trained learning model to the server after the client trains the learning model.

10. The method of claim 9, wherein the information on the learning model and the information on the trained learning model are weights for the learning model.
